(19) United States
(12) Patent Application Publication
(10) Pub. No.: US 2015/0314298 A1
(43) Pub. Date: Nov. 5, 2015

(54) HAMMER FOR MATERIAL REDUCING MACHINES

(71) Applicant: ESCO Corporation, Portland, OR (US)

(72) Inventors: Ty D. Porter, Oregon City, OR (US); Michael B. Roska, Portland, OR (US); Severn D. Durand, Portland, OR (US)

(21) Appl. No.: 14/700,008

(22) Filed: Apr. 29, 2015

Related U.S. Application Data
(60) Provisional application No. 61/986,385, filed on Apr. 30, 2014.

(51) Int. Cl. B02C 13/28; B02C 13/04

(52) U.S. Cl. CPC B02C 13/28; B02C 13/04; B02C 2013/2812

(57) ABSTRACT

A multi-piece shredder hammer for use in a reducing machine. The multi-piece shredder hammer includes a base to be mounted to the reducing machine, a replaceable tip to be mounted to the base and to impact the material to be reduced, and a retainer to secure the replaceable tip to the base. The replaceable tip is installed on the base from a side of the base.

### RELATED APPLICATION

This application claims priority benefits to U.S. Provisional Patent Application No. 61/986,385 filed Apr. 30, 2014 which is incorporated herein by reference in its entirety.

### FIELD OF THE INVENTION

The present invention relates to industrial material reducing systems. More particularly, this invention relates to reducing systems that include shredder hammers.

### BACKGROUND OF THE INVENTION

Industrial shredding equipment typically is used to break large objects into smaller pieces that can be more readily processed. Commercially available shredders range in size from those that shred materials like sugar cane, rocks, clay, rubber (e.g., car tires), wood, and paper to larger shredding systems that are capable of shredding scrap metal, automobiles, automobile body parts, and the like.

FIG. 1 schematically illustrates an exemplary industrial shredding system 10a. As an example only, the system is shown shredding sugar cane. Shredding system 10a includes a material intake 12a (such as conveyor) that introduces material 14a to be shredded to a shredding chamber 16a. The material 14a to be shredded may be of any desired size or shape. The material 14a is optionally pretreated, such as by heating, cooling, crushing, baling, etc. before being introduced into the shredding chamber 16a. The material intake 12a may optionally include levelers 11a, feed rollers 13a, or other machinery to facilitate feeding material 14a to chamber 16a, and/or to control the rate at which material 14a enters chamber 16a, and/or to prevent the material 14a from moving backward on the conveyor 12a.

Because there are a wide variety of applications for shredding machines, from sugar cane processing to automobile shredding, there is a wide range and variety of shredder configurations. As examples, there are generally two types of shredders for processing sugar cane: vertical shredders and horizontal shredders. In a vertical shredder (FIG. 1), knives 15a may be used to initially break up the sugar cane so that the material is the appropriate size for the shredding process. A rotary shredding head 18a spins with a direction of rotation indicated by arrow 27a that is in-line with the direction of rotation of the conveyor 12a. Rotary shredding head 18a is configured to rotate about a shaft or axis 20a, and is equipped with a plurality of shredder hammers 22a to impact the sugar cane against a hardened surface 24a to break the material apart. The hardened surface may be, for example, the feed roller, an anvil, a grate, chamber walls, or adjacent hammers. In the illustrated example, hammers 22a work in cooperation with chamber walls and grates. The rotary shredding head may have, for example, 50 to 200 hammers to break up the material. Each shredder hammer 22a is independently pivotally mounted to the rotary shredding head 18a with a mounting pin 26a (FIGS. 3 and 4). In response to centrifugal forces as shredding head 18a rotates, each hammer extends outward, tending toward a position where the center of gravity of each hammer is spaced outward as far as possible from rotation axis 20a when no material is in the chamber. The shredding chamber 16a may have one or more additional rotary shredding heads 18a to further break up the material. The shredded material may then be discharged onto another conveyor for transportation to further processing.

FIG. 2 shows one example of a horizontal shredder. In this embodiment of a horizontal shredder, a rotary shredding head 18b spins with a direction of rotation indicated by arrow 27b. Similar to the vertical shredder the horizontal shredder is equipped with a rotary shredding head 18b that is configured to rotate about a shaft or axis 20b, and is equipped with a plurality of shredder hammers 22b to impact the sugar cane against a hardened surface 24b to break the material apart. The shredded material may then be discharged onto the same conveyor for transportation to further processing. Alternatively, the material may be discharged onto a separate conveyor as disclosed in US Patent Application 2008/0277514.

Shredder hammers are routinely exposed to extremely harsh conditions of use, and typically are constructed from especially durable materials, such as hardened steel materials, such as low alloy steel or high manganese alloy content steel.

Each shredder hammer may weigh, for example, between 50 and 1200 lbs. During typical shredder operations these heavy hammers impact the material to be shredded at relatively high rates of speed. Even when employing hardened materials, the typical lifespan of a shredder hammer may, for example, only be a few days up to approximately 45 days. In particular, as the shredder hammer blade or impact area undergoes repeated collisions with the material to be processed, the material of the shredder hammer tends to wear away.

Once the hammers have been worn the worn, hammers must be replaced with new hammers. The hammers often cannot be replaced very easily. In some shredders, such as sugar cane shredders, the hammers are located within the shredding equipment such that they must be replaced by a human operating under limited conditions. Because of the weight of the hammers and the confined space in which the installer must be located to replace the hammers, it can be a difficult process and the installer is at risk of being injured while replacing the worn hammers.

In an attempt to minimize the weight to be handled by those working on shredders and ease the replacement of worn hammers, two piece hammers have been used with varying degrees of success (the hammers may have more than three parts but are referred to as two piece hammers on account of a having a base and a replaceable impact part). For example, U.S. Pat. No. 2,397,776 (US '776) discloses a two piece hammer with two shanks that are rotated into a replaceable tip. However, the two piece hammer in US '776 requires the entire hammer to be disassembled in order to replace the tip. Needing to disassemble each hammer to replace the tips increases the downtime of the material reducing machine. U.S. Pat. No. 3,367,585 (US '585) discloses another example of a two piece hammer. In US '585 the replaceable tip is slid onto the shank and a pin passes through the tip and shank. Once the pin has been welded to the replaceable tip, the tip is maintained on the shank. Welding a pin onto the replaceable tip increases downtime of the equipment as the weld must be removed and a new weld put in place each time a tip is replaced. In addition it can increase the potential danger to the installer if the welding equipment needs to be used in confined spaces.

It should be appreciated that the greater throughput that the shredding equipment can process, the more efficiently and profitably the equipment can operate (i.e., minimal downtime for the shredding machine is desired). Accordingly, there is room in the art for improvements in the structure and construction of two piece shredder hammers and the machinery and systems utilizing such hammers.

Examples of shredder hammers and industrial shredding equipment are disclosed in U.S. Pat. No. RE14865, U.S. Pat. No. 1,281,829, U.S. Pat. No. 1,301,316, U.S. Pat. No. 2,331,597, U.S. Pat. No. 2,467,865, U.S. Pat. No. 3,025,067, U.S. Pat. No. 3,225,803, U.S. Pat. No. 4,049,202, U.S. Pat. No. 4,083,502, U.S. Pat. No. 4,310,125, U.S. Pat. No. 4,373,679, U.S. Pat. No. 6,102,312 and U.S. Pat. No. 7,325,761. The disclosures of these and all other publications referenced herein are incorporated by reference in their entirety for all purposes.

### SUMMARY OF THE INVENTION

The present invention generally pertains to shredding operations and to multi-piece hammers referred to as two piece hammers that can quickly and easily be replaced when worn.

In one aspect of the invention, a replaceable tip for a hammer to separate material in a reducing machine has mounting end with a plurality of bearing surfaces to bear against corresponding bearing surfaces on a base wherein the bearing surfaces are at an acute angle to the centrifugal force experienced during use of the tip.

In another aspect of the invention, the tip has a transverse protrusion to fit within an opening in the base where the protrusion has a depth in a direction of insertion into the opening, a length and a width shorter than the length.

In another aspect of the invention, the tip has a mounting end and a wear end, that are connected by a single protrusion extending downward from one of the said side surface on the mounting end to one of the said side surfaces of the wear end so that the other of the said side surfaces on the mounting end and the other said side surfaces on the wear end are free of a connection.

In another aspect of the invention, the tip has an interior surface with a front end, a bottom end, and a transition surface that curves from the front end toward the bottom end, wherein the transition surface generally matching a shape of the exterior wear surface once the tip has experienced wear.

In another aspect of the invention, the tip has a fulcrum about which the tip rotates to mount to the base.

In another aspect of the present invention, a multi-piece hammer includes a base, a replaceable tip, and a retainer. Both the base and the tip include a leading portion in the primary direction of rotation, a trailing portion opposite the leading portion, and a pair of side portions extending between the leading and trailing portions. To install the tip on the base, the tip is pivoted onto the base from one of the side portions of the base.

In another aspect of the invention, the tip is rotated about a pivot axis on the base to install the tip on the base. The angle of the pivot axis on the base is between 35 and 90 degrees relative to the centrifugal force of the hammer spinning around the drum. In one preferred construction, the angle of the pivot axis is 45 degrees relative to the centrifugal force.

In another aspect of the invention, the tip has a mounting end to mount the tip to the base and a wear end for impacting the material to be shredded. Both the mounting end and the wear end have a leading portion in the primary direction of rotation, a trailing portion opposite the leading portion, and a pair of side portions extending between the leading and trailing portions. The mounting end is connected to the wear end by a single protrusion extending downward from one of the side portions on the mounting end to one of the side portions of the wear end so that the wear end of the tip and the mounting end are secured to each other on only one of each of their sides.

In another aspect of the invention, the tip has a protrusion that extends through the base from one of the side surfaces of the base to the other side surface of the base. In one preferred construction the protrusion has an upper surface and a lower surface that are generally parallel to the pivot axis on the base. The upper surface of the protrusion on the tip is engaged with a retainer to secure the tip to the base. Having the tip and retainer arranged in such a way minimizes the centrifugal loads the retainer experiences as the hammer rotates about the drum.

In another aspect of the invention, the base has a recess that is generally parallel to the pivot axis on the base to receive a retainer to secure the tip to the base. A retainer is slid within the recess to engage the tip.

In another aspect of the invention, the tip has a transition surface within the wear surface of the tip that is generally rounded. In one preferred construction, the rounded transition surface curves from the front end toward the bottom end. The curved surface of the replaceable tip generally matches the exterior wear profile of the tip once worn. Having an interior transition surface that matches the exterior wear profile of the worn tip allows the tip to be worn a significant amount without the base being worn.

In another aspect of the invention, the tip has bottom bearing surface in the bottom end of the tip that is generally parallel to the centrifugal force of the hammer spinning around the drum and generally perpendicular to the primary load force. Preferably the front bearing surface and the bottom surface are connected to each other by a generally smooth transition surface and the bottom bearing surface directly opposes a front strike face of the tip.

In another aspect of the invention, the tip has a plurality of bearing surfaces generally parallel to the centrifugal force of the hammer spinning around the drum. In one preferred construction, the tip also has a pair of lateral thrust surfaces to bear against the base and retainer when lateral loads are experienced.

In another aspect of the invention, the tip is secured to the base by a retainer that abuts a protrusion on the tip without extending through the tip. The retainer is preferably oriented so that the retainer generally only experiences loading when the tip is subjected to lateral loads. In one preferred construction, the retainer does not protrude laterally through the base or the tip.

Other aspects, advantages, and features of the invention will be described in more detail below and will be recognizable from the following detailed description of example structures in accordance with this disclosure.

### BRIEF DESCRIPTION OF THE DRAWINGS

FIG. 1 is a schematic depiction of a prior art vertical shredding system.

FIG. 2 is a schematic depiction of a prior art horizontal shredding system.

FIGS. 3 and 4 are perspective views of the rotating head of FIG. 1.

FIG. 5 is a schematic depiction of a horizontal shredding system equipped with one embodiment of hammers in accordance with the present invention.

FIG. 6 is a partial perspective view of the rotating head of FIG. 5.

FIGS. 7 and 8 are side views of the multi-piece hammer shown in FIG. 5.

FIG. 9 is a partial front perspective view of the multi-piece hammer shown in FIG. 5.

FIG. 10 is a cross sectional view of the multi-piece hammer shown in FIG. 5 taken along lines 10-10 in FIG. 7.

FIGS. 11 and 12 are front perspective views of the multi-piece hammer shown in FIG. 5.

FIGS. 13 and 14 are side views of the base of the hammer shown in FIG. 5.

FIG. 15 is a front view of the base of the hammer shown in FIG. 5.

FIG. 16 is a partial side view of the base of the hammer shown in FIG. 5.

FIG. 17 is a bottom view of the base of the hammer shown in FIG. 5.

FIG. 18 is a side view of the tip of the hammer shown in FIG. 5.

FIG. 19 is a rear perspective of the tip of the hammer shown in FIG. 5.

FIG. 20 is another side view of the tip of the hammer shown in FIG. 5.

FIG. 21 is a rear view of the tip of the hammer shown in FIG. 5.

FIG. 22 is a top view of the tip of the hammer shown in FIG. 5.

FIG. 23 is a perspective view of the retainer that secures the tip to the base of the hammer shown in FIG. 5.

FIG. 24 is a rear perspective view of the tip of the hammer shown in FIG. 5 being rotated onto the base.

FIG. 25 is a rear perspective view of the tip of the hammer shown in FIG. 5 fully rotated onto the base.

FIGS. 26 and 27 are side views of an alternative embodiment of a multi-piece hammer of the present invention.

FIG. 28 is a partial side view of the hammer shown in FIGS. 26 and 27.

FIG. 29 is a cross sectional view of the multi-piece hammer shown in FIGS. 26 and 27 taken along lines 29-29 in FIG. 28.

FIG. 30 is a partial front perspective view of the multi-piece hammer shown in FIGS. 26 and 27.

FIGS. 31 and 32 are side views of the base of the hammer shown in FIGS. 26 and 27.

FIG. 33 is a cross sectional view of the base of the hammer shown in FIGS. 26 and 27 taken along lines 33-33 in FIG. 31.

FIG. 34 is a front perspective view of the tip of the hammer shown in FIGS. 26 and 27.

FIG. 35 is a rear perspective view of the tip of the hammer shown in FIGS. 26 and 27.

FIG. 36 is a top view of the tip of the hammer shown in FIGS. 26 and 27.

FIG. 37 is a rear view of the tip of the hammer shown in FIGS. 26 and 27.

FIG. 38 is a side view of the tip of the hammer shown in FIGS. 26 and 27.

FIG. 39 is a bottom view of the tip of the hammer shown in FIGS. 26 and 27.

FIG. 40 is another side view of the tip of the hammer shown in FIGS. 26 and 27.

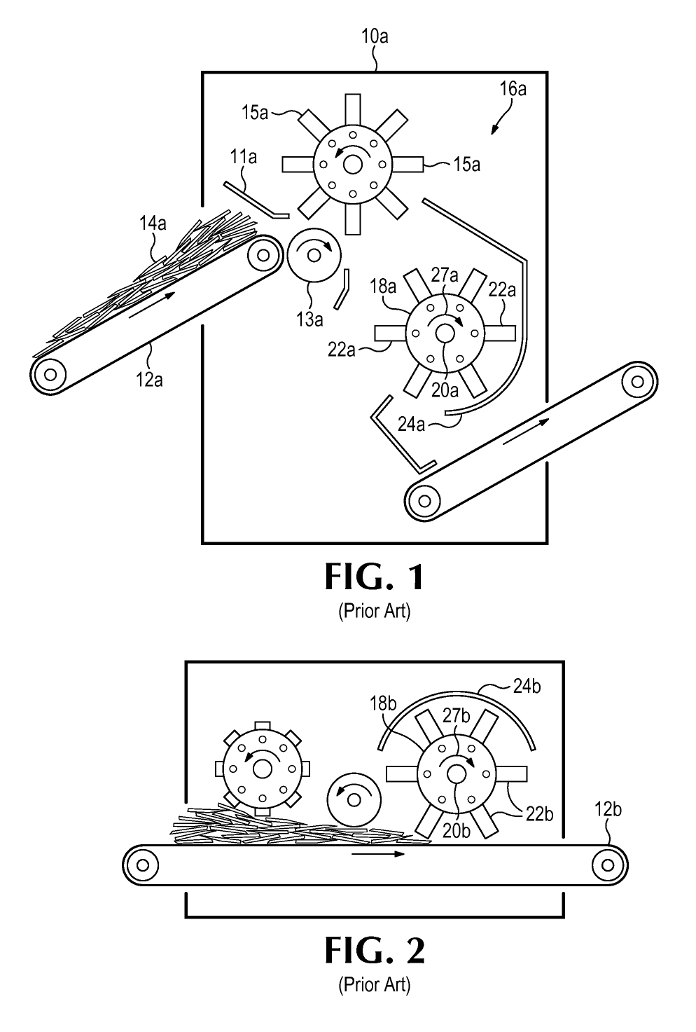

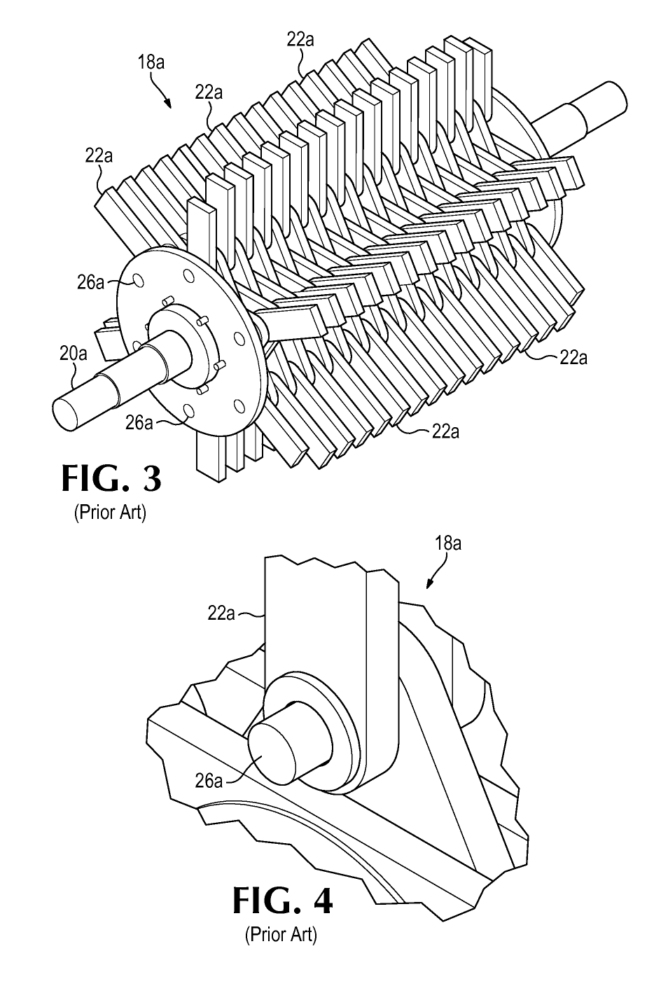

### DETAILED DESCRIPTION OF THE PREFERRED EMBODIMENTS

The present invention relates to industrial material reducing systems and machines (e.g., industrial shredders. More particularly, this invention relates to material reducing machines that include hammers. The material reducing machine is provided with multiple hammers with multiple pieces comprising a shank or base and a replaceable tip. The multi-piece hammers are particularly well suited for use in sugar cane shredders but other uses are possible.

Relative terms such as front, rear, top, bottom and the like are used for convenience of discussion, and are generally used to indicate the orientation of the hammer while the hammer is at rest (i.e., while the drive shaft of the material reducing equipment is at rest). The front end is generally used to indicate the end that initially impacts the material to be reduced, the rear end is generally used to indicate the end opposite the front end, the top end is generally used to indicate the end closest to the drive shaft, and the bottom end is generally used to indicate the end opposite the top end. Nevertheless, it is recognized that when operating the system the hammers attached to the drum may be oriented in various ways as the drum rotates. Additionally, as the hammers impact material they may move back and forth on the pin during use.

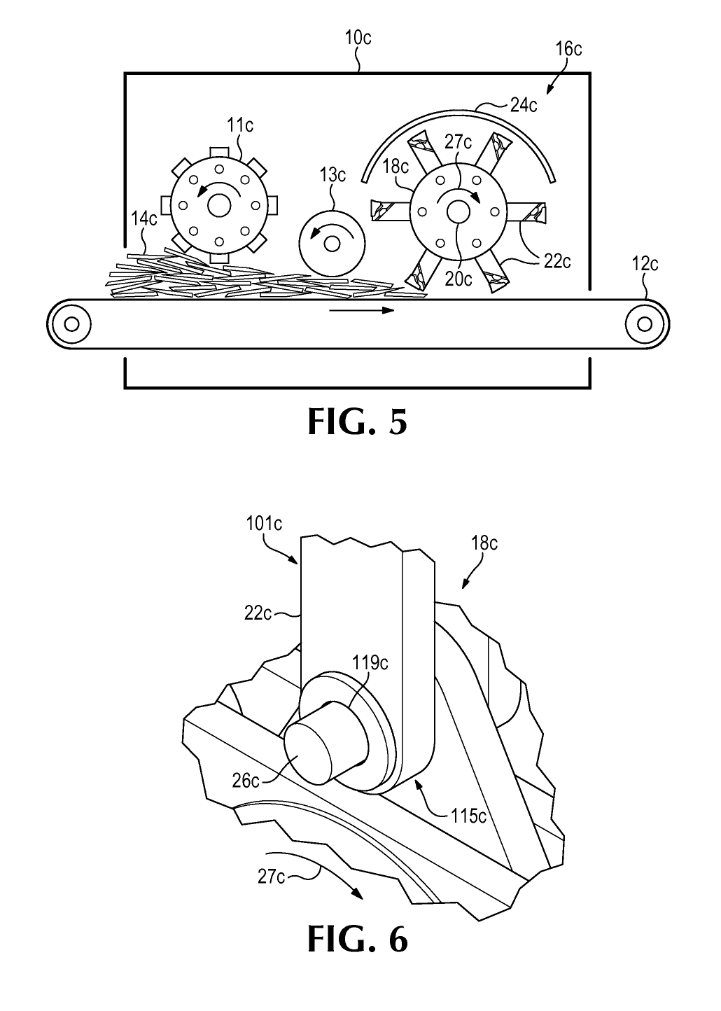

FIGS. 5 and 6 show an example of a horizontal shredder 10c equipped with hammers 22c of the present invention. In the illustrated embodiment, the operation is shown shredding sugar cane. It should be understood that aspects of the hammers of the present invention may be used with hammers for vertical shredders or other shredders for processing rocks, clay, rubber (e.g., car tires), wood, paper, scrap metal, automobiles, automobile body parts, and the like.

A material intake 12c (such as a conveyor) introduces material 14c to be reduced into a reducing chamber 16c. The material 14c to be shredded or reduced may be of any desired size or shape. The material intake 12c may optionally include levelers 11c, feed rollers 13c, or other machinery to facilitate feeding material 14c into chamber 16c, and/or to control the rate at which material 14c enters chamber 16c, and/or to prevent the material 14c from moving backward on the conveyor 12c.

A plurality of hammers 22c attached to the head 18c spin at high speeds about a shaft or axis 20c in a direction of rotation indicated by arrow 27c to impact and separate material into smaller portions allowing the reduced material to be further processed in downstream operations. The rotary head 18c may have, for example, 50 to 200 hammers to break up the material. Each hammer 22c is independently pivotally mounted to the rotary head. In response to centrifugal forces as head 18c rotates, each hammer extends outward, tending toward a position where the center of gravity of each hammer is spaced outward as far as possible from rotation axis 20c when no material is in the chamber. The target material is initially impacted by a leading impact face of the hammer passing a hardened surface 24c near the material inlet. The hardened surface may be, for example, the feed roller, an anvil, chamber walls, or adjacent hammers; in this example, it is an anvil. In response to material in the system contacting the hammer leading face, the hammers, in some cases, deflect and rotate backwards on the mounting pins 26c in the reducing chamber. Contact of the hammers 22c with the material 14c fed into the reducing machine fractures, compresses and shears the material into smaller pieces. The target material is reduced in size as the materials are compressed and reduced between the outer surface (i.e., the wear edge) of the hammer and the hardened surfaces in the reducing chamber. The shredded material may then be discharged onto a conveyor for transportation to further processing.

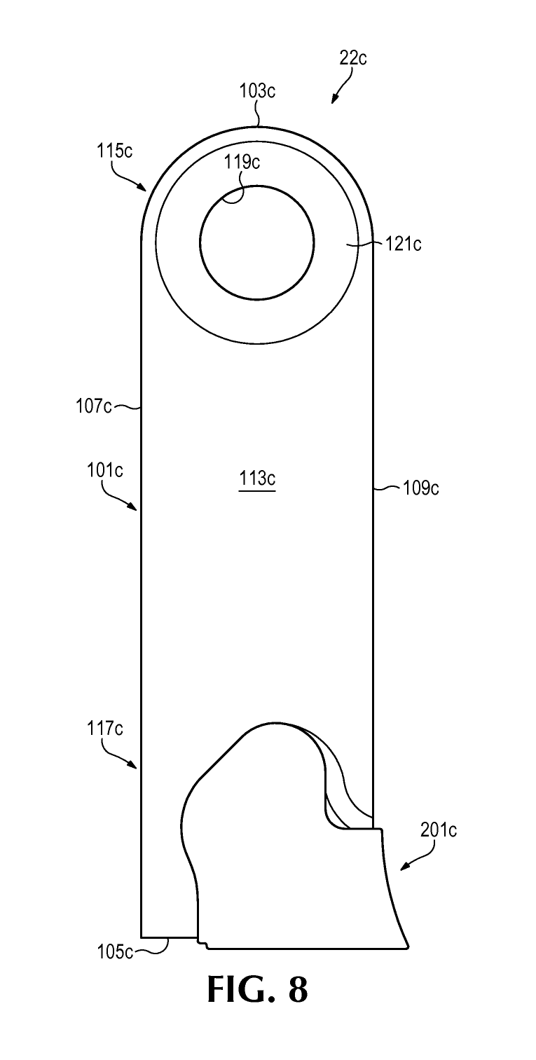

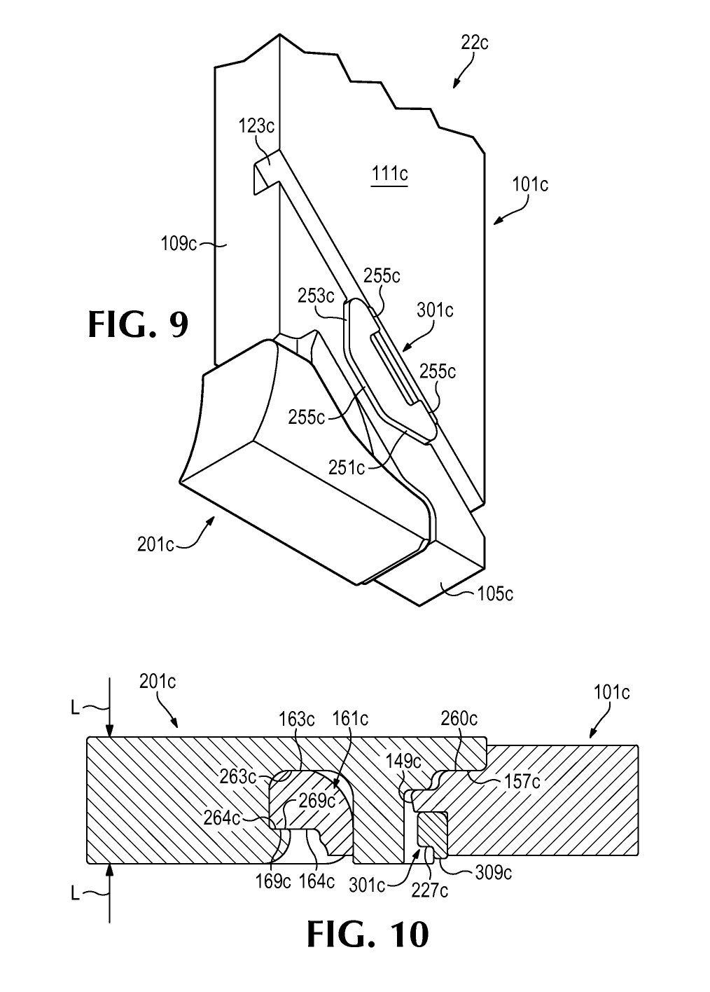

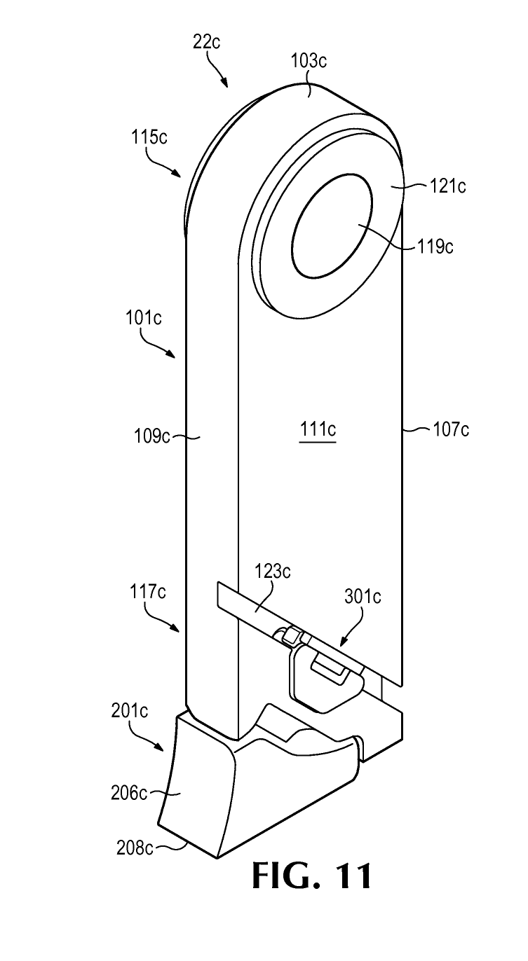

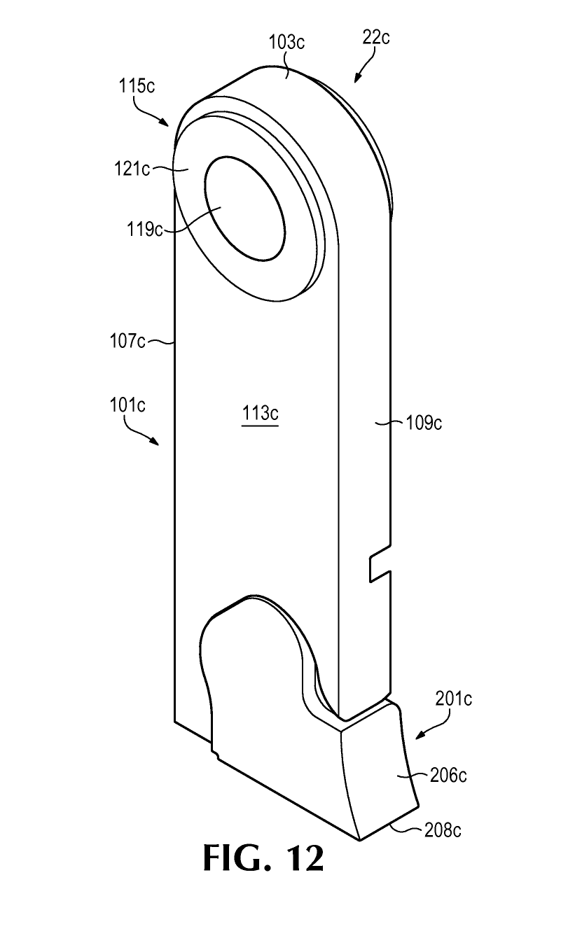

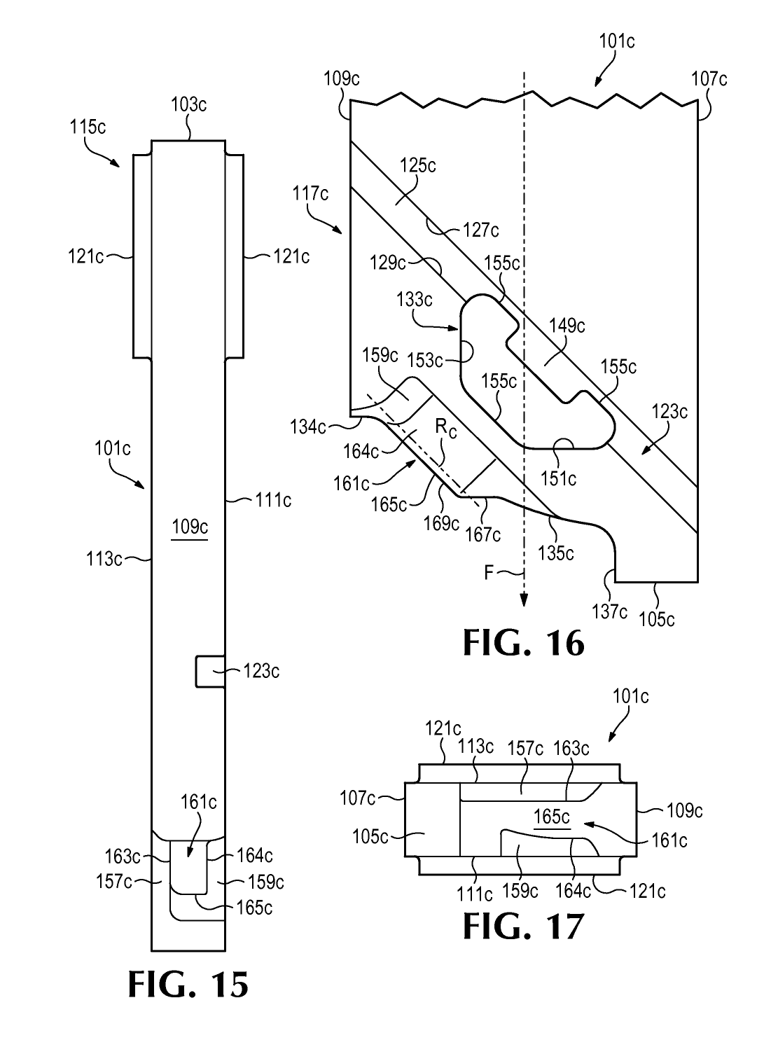

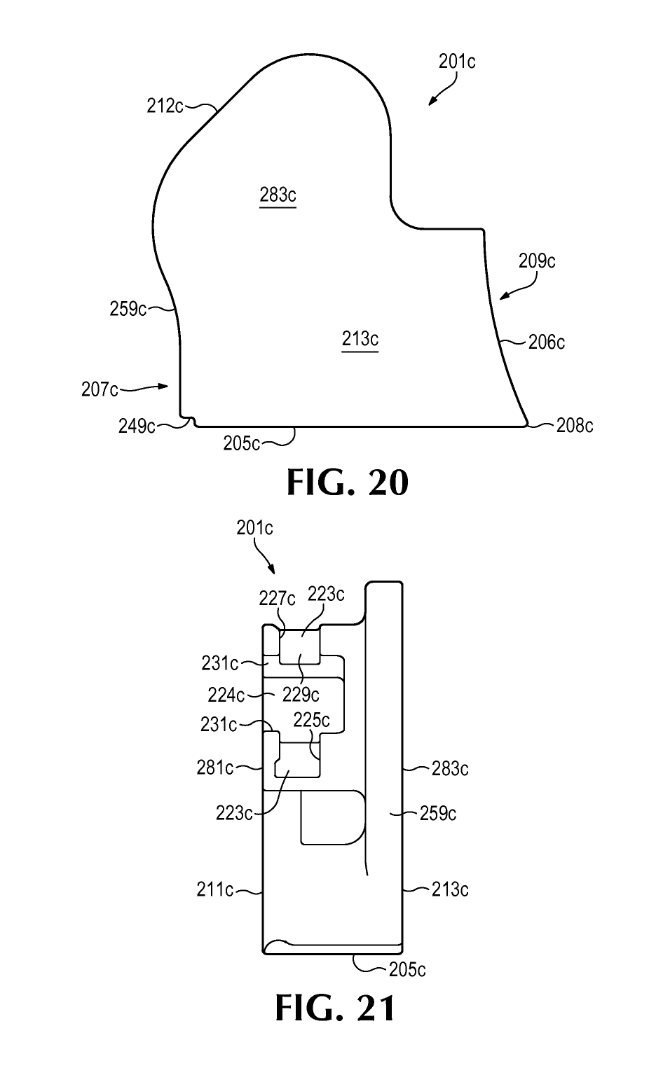

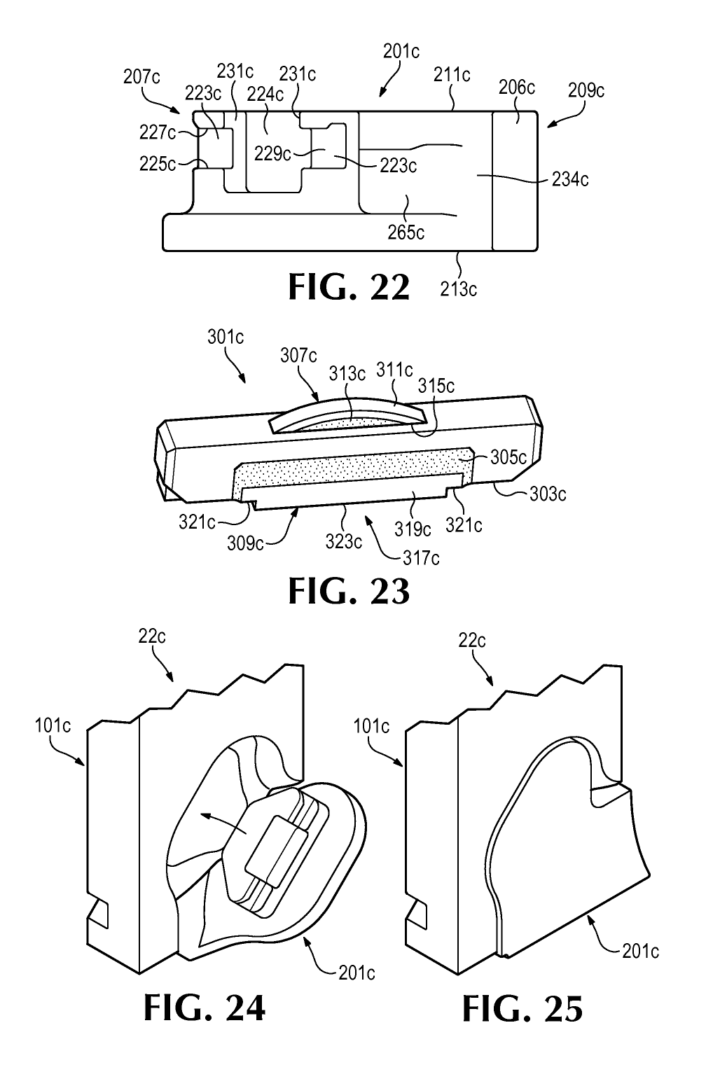

In one preferred embodiment (FIGS. 5 to 25), hammers 22c are made of a shank or base 101c and a replaceable tip 201c. The replaceable tip 201c is secured to the base 101c with a retainer 301c. Base 101c is shown as having a generally rectangular shape with a top surface 103c adjacent to the mounting pin 26c on head 18c, a bottom surface 105c opposite the top surface 103c, a rear surface 107c facing away from the leading face of the hammer, and a front surface 109c facing the same direction as the leading face of the hammer, and two side surfaces 111c and 113c between the front and rear surfaces 107c and 109c. The general shape of the base is not intended to be limiting as the shape of the base will vary depending on the material to be reduced or shredded and the type of machine the hammer is to be used in. For example, in alternative embodiments the base may generally have a tear drop shape, an elliptical shape, or a cylindrical shape.

Base 101c has a top mounting end 115c for mounting the hammer onto the head 18c and a bottom mounting end 117c for securing replaceable tip 201c to the base 101c. The top mounting end preferably has a through hole 119c for mounting the hammer on the mounting pin 26c of the head 18c, though other mounting arrangements are possible. Thickened portions 121c may be provided on the sidewalls 111c and 113c adjacent through hole 119c to reinforce the hole.

Top surface 103c is shown as being rounded. In addition, the thickness between the through hole 119c and the top surface 103c is shown as being relatively thin so that most of the mass of the base 101c is below the through hole. Having a majority of the mass below the through hole 119c maximizes the force the hammer 22c will have when the leading face impacts the material 14c to be reduced or shredded. The top surface 103c, however, may have a variety of shapes and the thickness between the through hole 119c and the top surface 103c may have a variety of thicknesses. Preferably, top surface 103c has sufficient clearance so that the hammers 22c may rotate on the mounting pins 26c without interference with other hammers 22c, pins, or the head 18c.

The bottom or distal mounting end 117c of base 101c is provided with a groove or recess 123c for receipt of retainer 301c. Recess 123c preferably extends all the way through the base 101c from the front surface 109c to the rear surface 107c. In alternative embodiments not shown, the groove have a different extension and may not extend completely through the front end 109c or rear end 107c. Recess 123c is angled to be generally parallel to a pivot axis R_{c} of the base 101c that allows the tip 201c to be pivoted onto the base 101c (as discussed below), though other arrangements are possible. The Recess 123c is preferably angled downward from the front surface 109c to the rear surface 107c so that the end of the recess closest to front surface 109c is generally closer to upper or proximate end 103c of base 101c and with the end of recess 123c closest rear end 107c is generally farther away from the proximate end 103c. The recess 123c has a downward angle Θ_{1c} relative to the centrifugal force F preferably between 35 and 55 degrees. Preferably, the centrifugal force F extends along the longitudinal axis of base 101x but other arrangements are possible. In one preferred embodiment, the angle Θ_{1c} of the recess 123c is 45 degrees relative to the centrifugal force F. Alternatively, the recess 123c may have an angle Θ_{1c} less than 35 degrees or greater than 55 degrees up to and including about 90 degrees (i.e., generally perpendicular to the centrifugal force F). However, in some embodiments, a recess may be omitted and an alternative retainer may be used to secure tip 201c to base 101c.

Recess 123c is shown as being generally U-shaped with an inner or side surface 125c, an upper or proximal surface 127c and lower or distal surface 129c. In a preferred embodiment, side surface 125c is generally perpendicular to proximal and distal surfaces 127c and 129c, and surfaces 127c and 129c are generally parallel to each other. The shape of the recess 123c is not intended to be limiting as alternative shapes are possible. For example, the proximal and distal surfaces may converge toward each other as they extend into the base, the recess may be generally triangular in cross section or have generally concave cross section, and the proximal and distal surfaces may converge toward each other as they extend toward the rear end 107c.

A through hole 133c extends through base 101c for receipt of protrusion 233c on tip 201c. Through hole 133c generally matches the shape of protrusion 233c. An upper portion of through hole 133c preferably extends into recess 123c through distal surface 129c and side surface 125c. Alternatively, the through hole 133c could extend through portions of each of the proximal, distal, and side surfaces 125c, 127c, 129c or extend only partially through any of the surfaces.

Through hole 133c preferably has at least one surface 151c that is generally normal to the centrifugal force F of the hammer spinning around the drum, at least one surface 153c that is generally parallel to the centrifugal force F of the hammer spinning around the drum, and multiple surfaces 155c that are generally parallel to the axis of rotation R_{c} (FIG. 16). However, there is still benefit in a through hole 133c that has multiple surfaces 155c that are generally parallel to the axis of rotation R_{c} that does not have at least one surface parallel to the centrifugal force F and/or one surface that is normal to the centrifugal force F.

A protrusion 149c preferably extends downward or outward generally normal to the pivot axis R_{c} into through hole 133c preferably as a part of side surface 125c. When hammer 22c experiences lateral loads L, protrusion 149c is a lateral bearing face between the tip 201c and the retainer 301c (FIG. 10). Protrusion 149c has a length that is preferably generally parallel to the axis of rotation R_{c} (FIGS. 13 and 16).

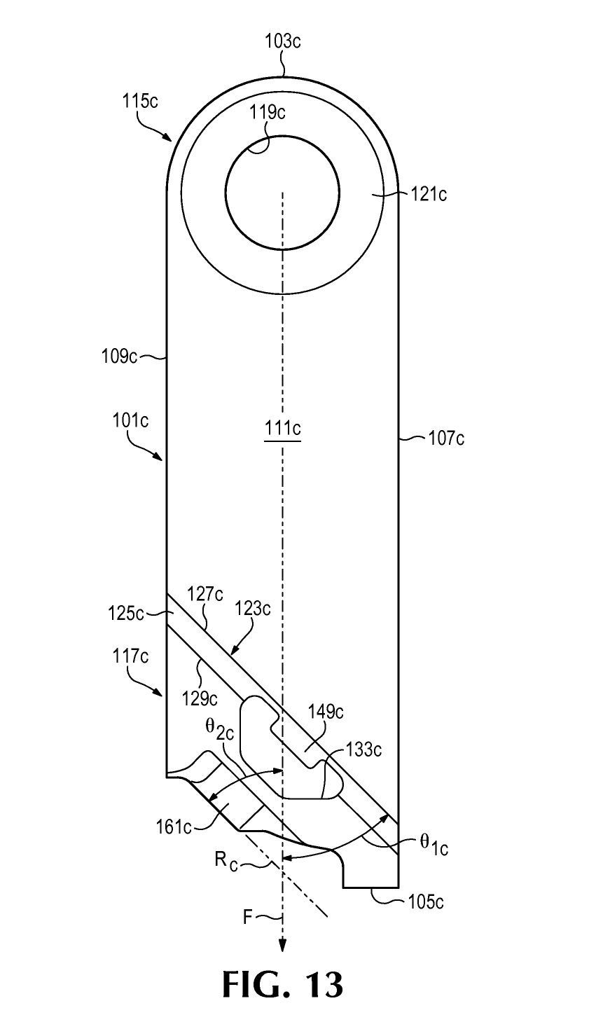

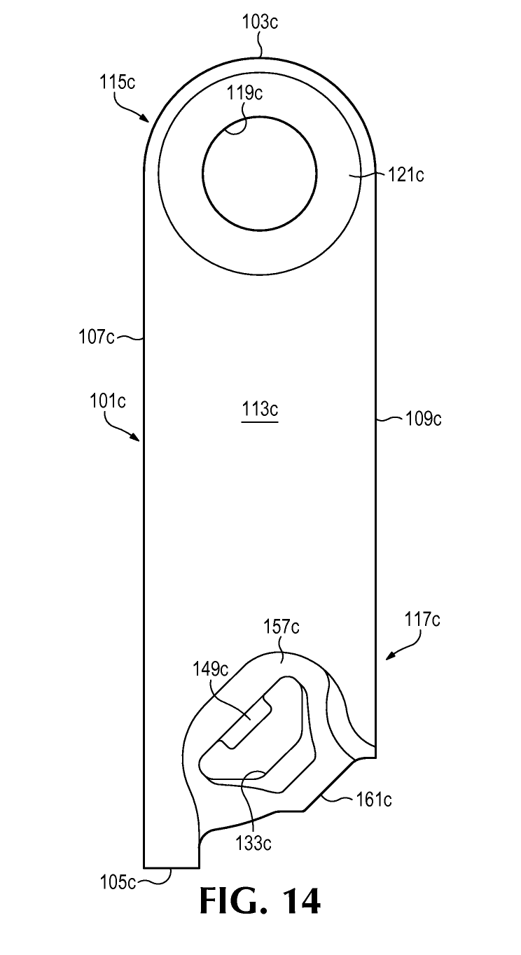

A recess 157c extends into sidewall 113c of base 101c (FIG. 14). Recess 157c generally corresponds to the shape of a peripheral sidewall 259c of the mounting portion of tip 201c. Recess 157c is shaped and sized to allow tip 201c to have sufficient space to pivot onto base 101c. Once tip 201c is pivoted onto base 101c, an inner surface 260c within sidewall 259c fits within recess 157c so that the side surfaces bear against each other and prevent further inward pivoting of the tip 201c on the base 101c. Preferably recess 157c has a depth that is shallower than the depth of sidewall 259c. This allows a portion of sidewall 259c to stick out farther from sidewall 113c and minimizes the wear that base 101c will experience. In alternative embodiments, sidewall 113c can be formed with no recess 257c and sidewall 259c may rest against an exterior surface of the base 101c or recess 157c may have a depth that maintains sidewall 259c in a completely recessed position.

A recess 159c extends into sidewall 111c of base 101c (FIG. 16). As with recess 157c in sidewall 113c, recess 159c generally corresponds to the shape of a sidewall 264c of recess 261c of tip 201c (FIG. 19). Recess 159c is sized and shaped to allow tip 201c to have sufficient space to pivot onto base 101c. Preferably recess 159c has a depth that allows a portion of sidewall 211c to stick out farther from sidewall 111c of base 101c.

Recess 159c helps define a central protrusion 161c that tip 201c bears against. The two side walls 163c and 164c of protrusion 161c primarily bear against tip 201c when experiencing lateral loads L. A bottom edge 169c along sidewall 164c and adjacent bottom surface 165c of protrusion 161c defines pivot axis R_{c} about which tip 201c rotates onto base 101c. Pivot axis R_{c} has an upward angle Θ_{2c} relative to the centrifugal force F between 35 and 55 degrees to mirror the wear profile of the tip 201c. In one preferred embodiment, the angle Θ_{2c} of pivot axis R_{c} is 45 degrees relative to the centrifugal force F. Alternatively, the pivot axis R_{c} may have an angle Θ_{2c} less than 35 degrees, greater than 55 degrees up to and including about 90 degrees (i.e., generally perpendicular to the centrifugal force F).

A front surface 134c is provided adjacent the front surface 109c. Front surface 134c is preferably spaced rearward from front surface 109c and is generally perpendicular to the centrifugal force F. Front surface 134c is primarily provided as a secondary bearing surface for bearing against the tip 201c under rebound conditions. Front surface 134c transitions into bottom surface 165c of protrusion 161c and bottom surface 165c transitions into a generally horizontal surface 167c (i.e., generally perpendicular to centrifugal force F). Alternatively, the front surface 134c may transition to a surface parallel to the centrifugal force F before transitioning to the bottom surface 165c. Other arrangements are possible.

Below surface 167c in the mounting section 117c of base 101c is a transition surface 135c, which in the preferred construction is rounded. Transition surface 135c generally matches a rounded transition surface 235c on tip 201c. Transition surface 135c extends downward towards the bottom surface 105c. Parts of the transition surface may generally match an outer wear profile of tip 201c. Transition surface 135c allows tip 201c to have more material for wearing. At the bottom of transition surface 135c a bottom bearing surface 137c is provided. Bearing surface 137c is preferably generally parallel to the centrifugal force F and generally perpendicular to primary load force P on tip 201c so that bottom bearing surface 137c acts as a primary bearing surface between the tip 201c and the base 101c, though other orientations are possible.

The replaceable tip 201c has a mounting end 217c to mount the tip to the base and a wear end 215c for impacting the material to be reduced. Both the mounting end 217c and the wear end 215c have leading portions 209c and 279c facing in the direction of the rotation of the hammer 22c, trailing portions or rear ends 207c and 277c opposite the leading portions 209c, 279c and pairs of side portions 211c, 213c, and 281c, 283c extending between the leading and trailing portions 209c, 207c and 279, 277. The mounting end 217c is preferably connected to the wear end 215c by a single protrusion or sidewall 259c extending downward from side portion 283c on the mounting end 217c to the side portion 213c on the wear end 215c so that the wear end 215c of the tip and the mounting end 217c are secured to each other on only one of each of their sides (i.e., only on sides 213c and 283c). Wear end 215c and mounting end 217c are spaced from each other so that sidewall 259c defines a cavity 239c between the wear end 215c and the mounting end 217c.

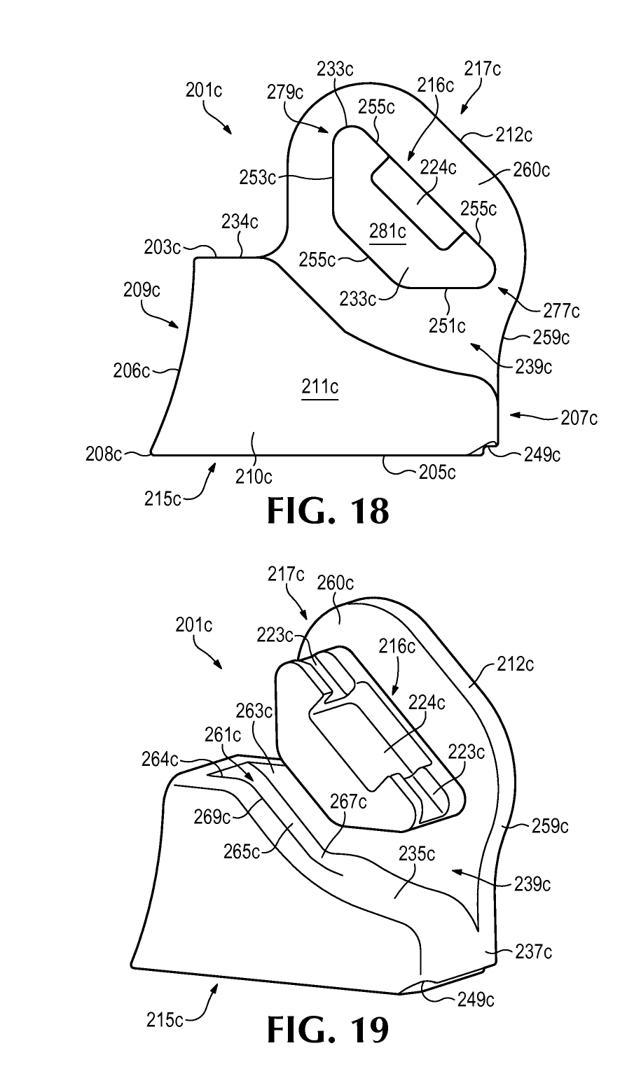

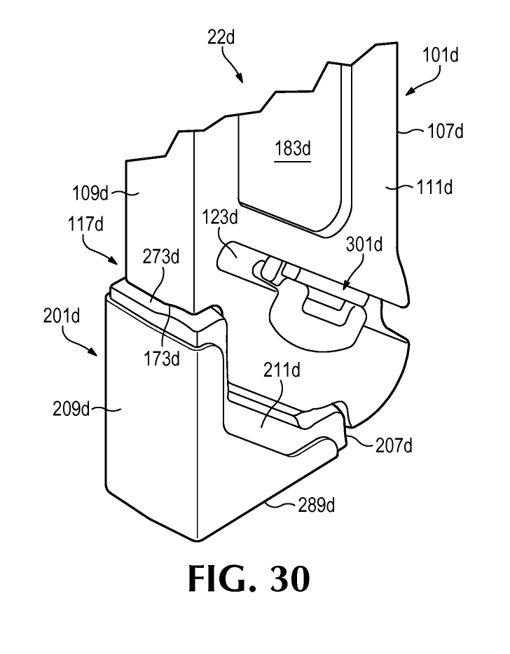

Together side surfaces 211c and 213c, front and rear surfaces 209c and 207c and bottom surface 205c make up the exterior surface 210c of the wear end 215c of the replaceable tip 201c (FIGS. 18-21). Generally, front surface 209c initially impacts the material 14c to be reduced. Front surface 209c and bottom surface 205c could have a variety of shapes and orientations. For example, front face 209c may be generally parallel to the centrifugal force or a front face 209c could have a sloped surface 206c that extends forward of base 101c and ends with a forward most impact surface 208c as shown. Similarly bottom surface 205c may have a variety of shapes, for example, the bottom surface may be generally perpendicular to the centrifugal force F as shown, or may have a convex or concave curve, and may be provided with recesses or grooves. It should be appreciated that other shapes of the exterior surface 210c are possible. For example, the exterior surface of the tip may have an exterior surface with recesses and notches and front and bottom surfaces that are orientated similar to hammers and crushing tips disclosed in U.S. Patent Applications 61/904,130, 61/803,043, or Ser. No. 13/897,340, or US Patent Publications 2013-0233955, or 2009-0174252 each of which is incorporated herein by reference. Additionally the exterior surface may be provided with one or more wear indicators 249c so that the operator can quickly tell if the replaceable tip 201c needs to be replaced. The wear indicators 249c may be placed anywhere along the wear profile of the tip and may, for example, be a notch located at the rear end 207c of the tip 201c. In addition, the front surface and sides of the tip may be covered with hard facing 289d as shown in FIG. 30, or provided with inserts of a different material than the body of the tip as disclosed in US Patent Publication 2013-0233955 which is incorporated herein by reference (not shown). The inserts may comprise a hardened material such as diamond, tungsten carbide or carbon nitride. The inserts may be held in cast or drilled holes in the tip or may be cast in place when the hammer is manufactured.

A recess or groove 261c extends into the top surface 203c of wear end 215c to define a bearing surface for bearing against protrusion 161c of base 101c. The side walls 263c, 264c of recess 261c primarily bear against base 101c when experiencing lateral loads L. Bottom surface 265c is generally aligned with bottom surface 165c of base 101c. In alternative embodiments, groove 261c may be located on the base 101c and the protrusion 161c may be located on the tip 201c.

As shown in FIGS. 18 and 22, the top surface 203c of wear end 215c has a front surface 234c to correspond to and bear against front surface 134c of tip 101c. Front surface 234c is preferably generally perpendicular to the centrifugal force F and generally 90 degrees to the primary bearing surface 237c on tip 201c and 137c on base 101c. Front surface 234c transitions into bottom surface 265c of recess 261c and bottom surface 265c transitions into a generally horizontal surface 267c (i.e., generally perpendicular to centrifugal force F).

Below surface 267c of tip 201c is a transition surface 235c. Transition surface 235c generally matches the rounded transition surface 135c on base 101c. Transition surface 235c curves downward. Parts of transition surface 235c may generally match an outer wear profile of tip 201c. Rounded transition surface 135c allows tip 201c to have more material for wearing. At the bottom of transition surface 235c a bottom bearing surface 237c is provided (FIG. 19). Bottom bearing surface 237c is preferably generally parallel to the centrifugal force F and generally normal to the primary load P applied during a shredding operation. During the shredding operation bearings surfaces 234c, 265c, 267c, 235c and 237c bear against respective bearing surfaces 134c, 165c, 167c, 135c and 137c on base 101c.

An edge 269c of recess 261c is designed to pivot about bottom edge 169c of base 101c when the tip 201c is rotated onto base 101c (i.e., edge 269c rotates about pivot axis R_{c} on base 101c FIGS. 10 and 19). Edge 269c is preferably angled at an upward angle Θ_{3c} between 35 and 90 degrees relative to the centrifugal force F, though other angles are possible.

Although numerous shapes are possible, the edge 212c of sidewall 259c is shown as generally matching the shape of a protrusion 233c on mounting end 217c of tip 201c. Edge 212c could be, for example, generally rectangular, oval, elliptical, etc. Once tip 201c is assembled on base 101c an inner surface 260c of sidewall 259c abuts a recess 157c on base 101c to prevent further inward rotation of the tip 201c.

Mounting end 217c has a protrusion 233c for receipt in a through hole 133c in base 101c. Protrusion 233c preferably generally matches the shape of through hole 133c. Through hole 233c preferably has at least one surface 251c that is generally normal to the centrifugal force F of the hammer spinning around the drum, one surface 253c that is generally parallel to the centrifugal force F of the hammer spinning around the drum, and multiple surfaces 255c that are generally parallel to the axis of rotation R_{c}. During the reducing operation surfaces 251c and 253c bear against respective surfaces 151c and 153c on base 101c.

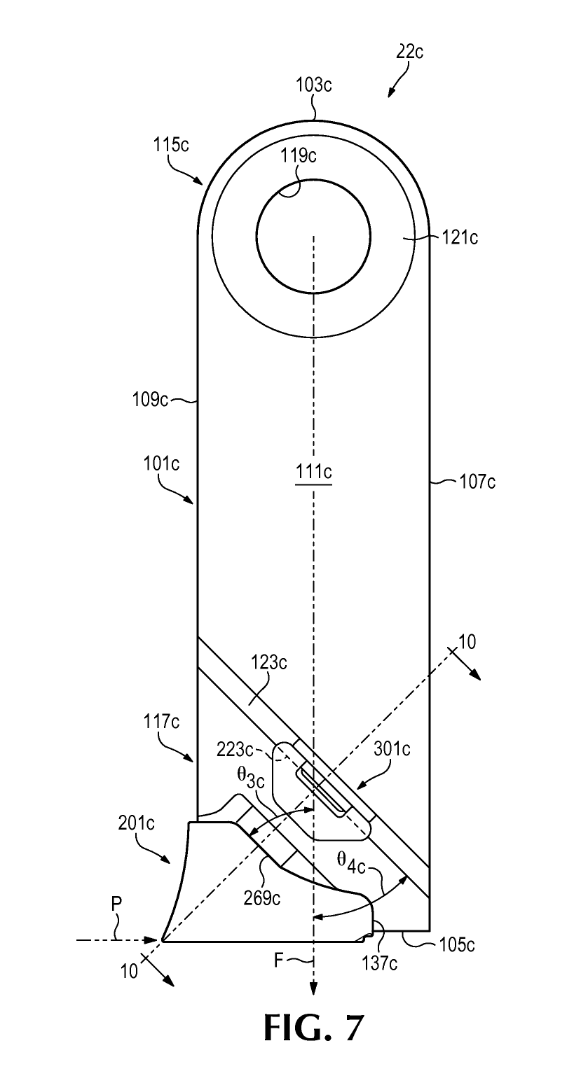

The top end 216c of mounting end 217c of tip 201c is provided with a groove 223c for receipt of retainer 301c. Groove 223c preferably extends all the way through the mounting end 217c from the front surface 279c to the rear surface 277c (FIG. 19). In alternative embodiments not shown, the groove may have a different extension and not extend completely through the front end 279c or the rear end 277c. Groove 223c is angled to be generally parallel to the pivot axis R_{c} of the base 101c (Groove 223 can be seen in FIG. 7 in phantom lines). The groove 223c is preferably angled downward from the front surface 279c to the rear surface 277c. The groove 223c has a downward angle Θ_{4c} preferably between 35 and 90 degrees relative to the centrifugal force F (i.e., the downward angle of groove 223c of tip 201c matches the downward angle of groove 123c of base 101c). As with groove 123c, groove 223c may be, for example, generally U-shaped with an inner surface 225c, an outer surface 227c, and a lower surface 229c. Grooves 123c and 223c form a passage for retainer 301c to travel between the base 101c and the tip 201c.

A recess 224c extends into the top end 216c of mounting end 217c (FIGS. 18-19). Recess 224c extends into mounting end 217c to a depth that is greater than the depth of groove 223c. Recess 224c extends substantially across the width of mounting end 217c so that the recess 224c opens into sidewall 281c. Recess 224c provides sufficient clearance for tip 201c to rotate onto base 101c (i.e., recess 224c allows clearance for protrusion 149c on base 101c as tip 201c rotates onto base 101c). In addition, recess 224c defines a pair of opposed lugs 231c that oppose protrusion 309c on retainer 301c to maintain the retainer in a secured position.

Many types of retainers are possible to hold tip 201c to base 101c. For example, retainer 301c may consist of a rigid casing 303c and at least one elastomeric member 305c and a pair of independently depressible protrusions 307c, 309c similar to the lock disclosed in U.S. Pat. No. 5,469,648 incorporated herein by reference.

The first protrusion 307c is preferably formed by elastomer 305c and an overlying shield, preferably in the form of a flexible loop member 311c. Loop member 311c encompasses a forward portion 313c of elastomer 305c and projects through a front opening 315c in the casing 303c. The loop member is preferably composed of spring steel, but could be formed of other materials having the requisite characteristics of strength, flexibility and durability. The shield could also be rigid and move in and out with the elastomer.

The second protrusion 309c is preferably formed by elastomer 305c and a shield in the form of a detent 317c. Detent 317c is preferably a rigid, metallic member which is adhered or otherwise secured to elastomer 305c. Detent 317c has a body 319c which is generally L-shaped and a pair of ends 321c. The rearward portion 323c of body 319c defines a projection adapted for receipt within the gap defined by recess 224c. Other materials, shapes and constructions are possible.

To assemble tip 201c on base 101c, edge 269c on tip 201c is aligned with the pivot axis R_{c} on base 101c (i.e., edge 269c of tip 201c is aligned with bottom edge 169c of base 101c). The tip 201c is then rotated (FIGS. 24 and 25) about the pivot axis R_{c} until inner surface 260c of sidewall 259c abuts a recess 157c on base 101c to prevent further inward rotation of the tip 201c. Retainer 301c is then preferably inserted into the bottom or back end of recess 123c on base 101c. As the retainer 301c is hammered or otherwise slid down recess 123c, elastomer 305c and the two protrusions 307c, 309c are compressed into the rigid casing 303c of retainer 301c. Retainer 301c is slid along recess 123c until the protrusion 309c reaches the gap formed by recess 224c on base 201c. At this point elastomer 305c causes protrusion 309c to expand outward from rigid casing 303c and ends 321c engage lugs 231c in recess 224c. In this position the retainer 301c is secured between grooves 123c and 223c and prevents tip 201c from rotating about base 201c. To remove the tip 201c, the retainer 301c is preferably slid out the top or front end of recess 123c. As the retainer is hammered or otherwise slid rearward protrusion 309c is compressed and retainer 301c is able to slide down and out of recess 223c and 123c. A drift pin or the like can be used to hammer the retainer out of the assembly. The tip 201c can then be pivoted off of the base 201c. Alternatively the retainer can be inserted from the front and removed from the rear end of the recess, the retainer can be inserted and removed from the same end of the recess, or the retainer may remain within the recess in the base during the installation and removal process.

It should be understood that other alternative retainers could be used to secure the tip 201c to the base 101c.

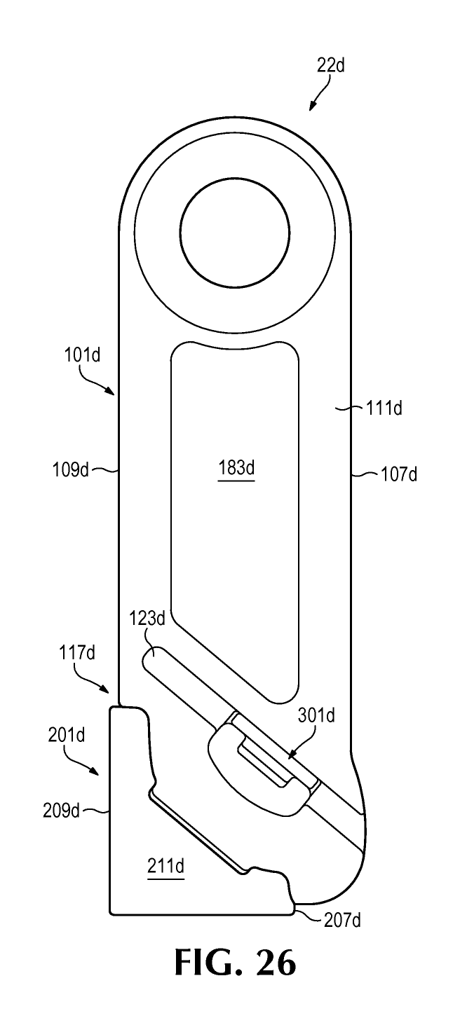

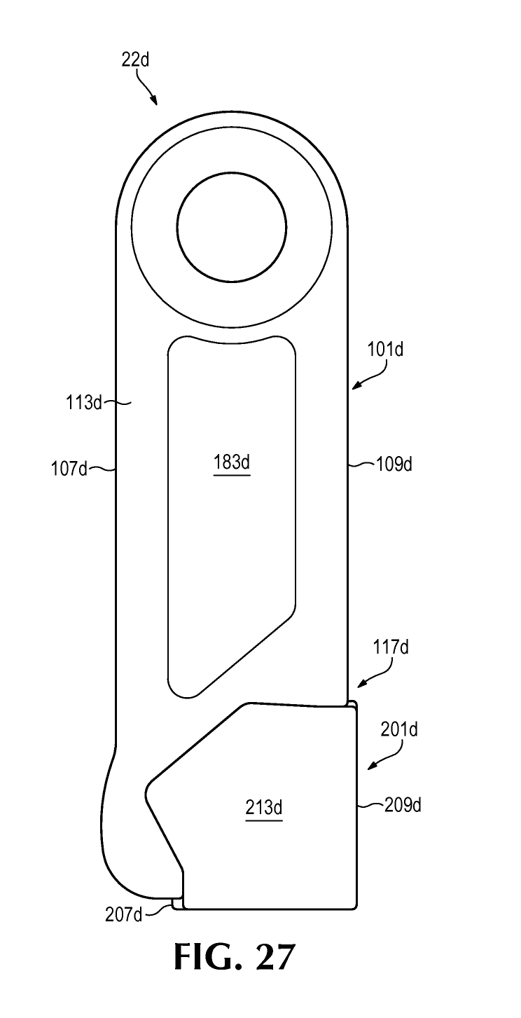

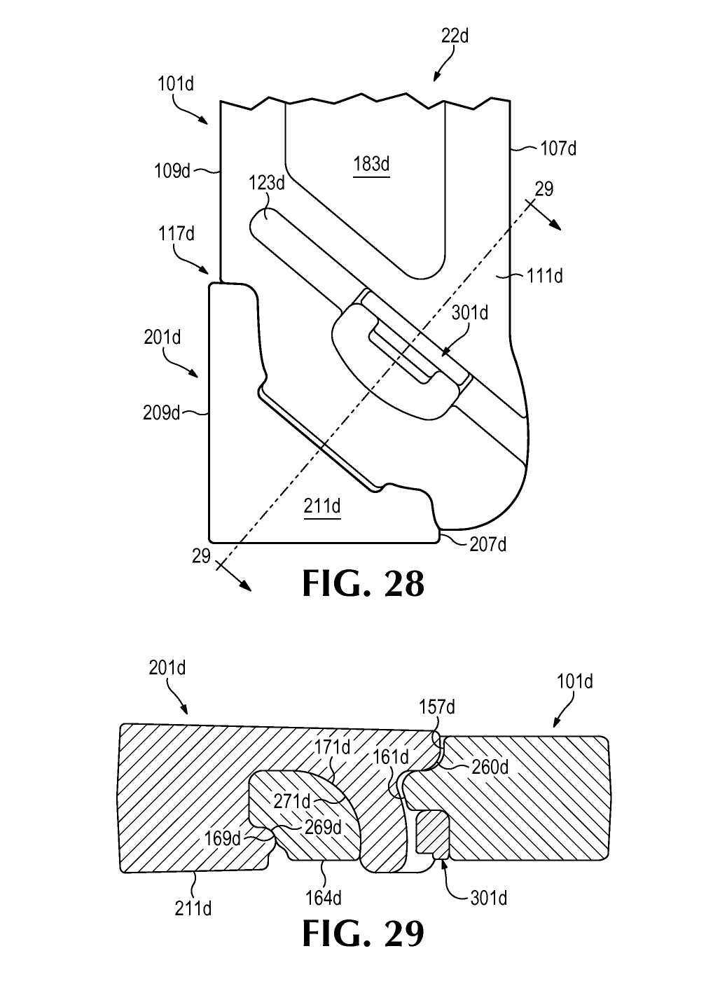

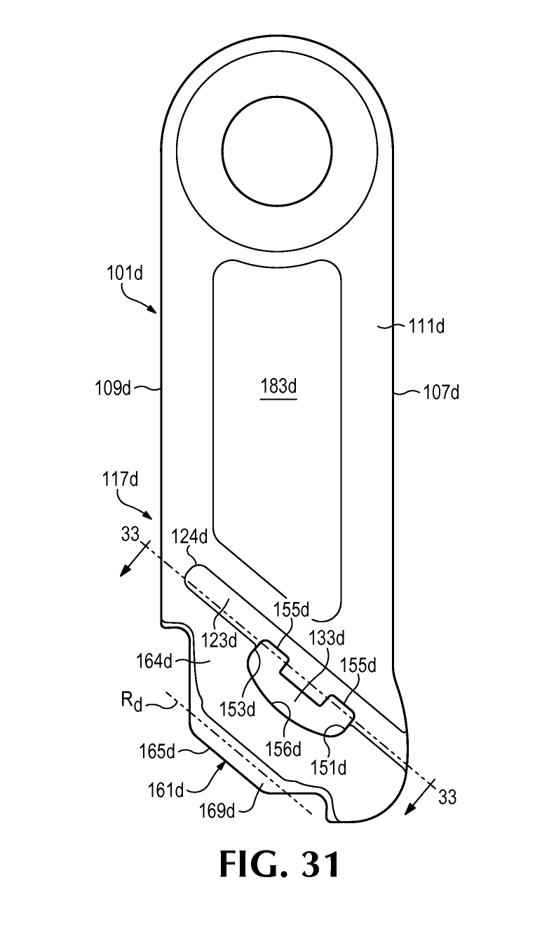

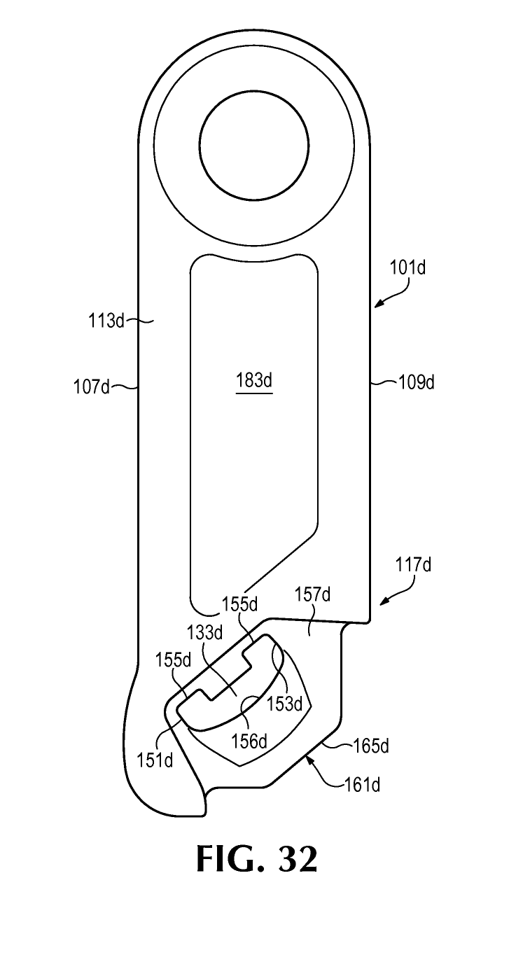

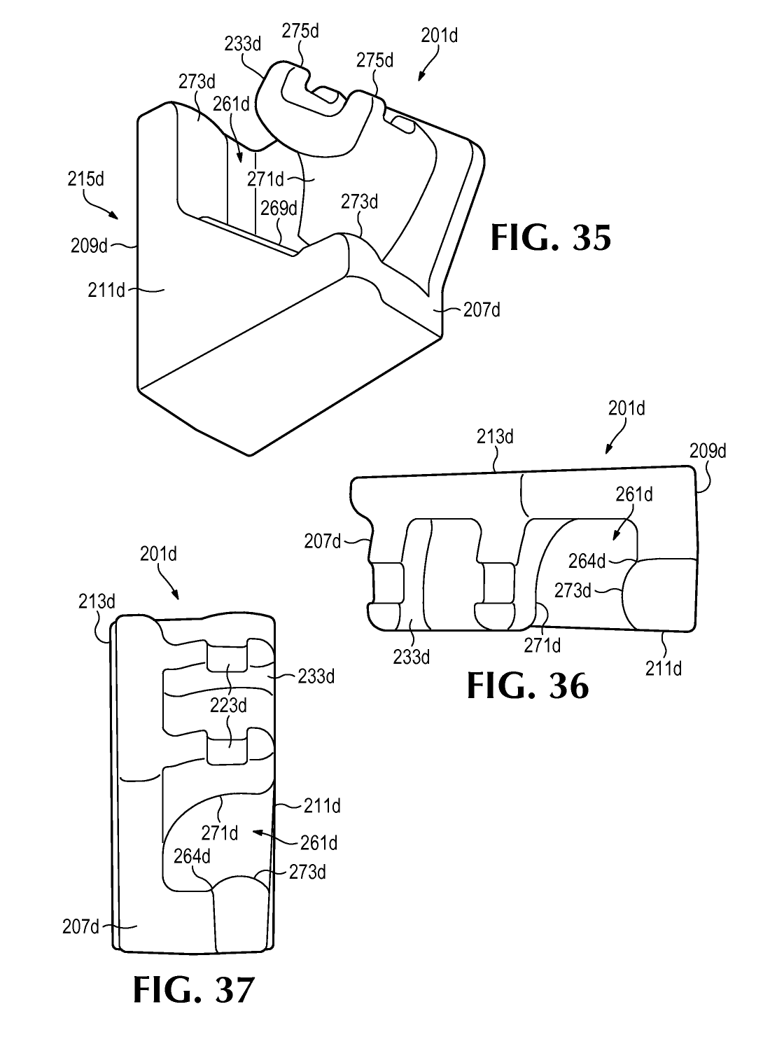

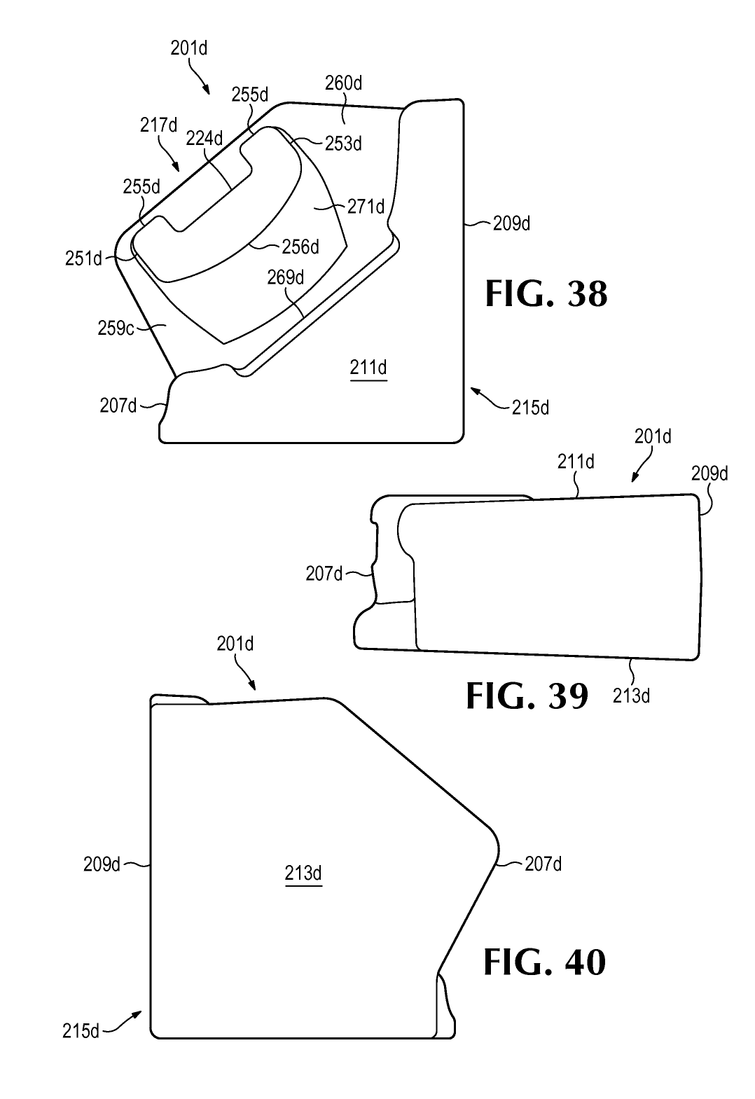

In an alternative embodiment shown in FIGS. 26-40, a multi-piece hammer 22d is provided with a base 101d and tip 201d that are similar in many ways to hammer 22c with many of the same benefits and purposes. The following discussion focuses on the differences and does not repeat all the similarities that apply to hammer 22d. For example, base 101d may have one or more recesses 183d extending into either side surface 111d and/or 113d to balance the hammer and obtain an optimal center of gravity for the hammer 22d. Similar to hammer 22d, hammer 22c may be provided with one or more recesses in the base 101c.

The outer side surfaces 211d and 213d of tip 201d are tapered backward from the front end 209d to the rear end 207d (i.e., the side surfaces 211d and 213d converge toward each other as they extend from front end 209d toward rear end 207d). The front end 209d has a larger width than the rear end 207d and the rear end 207d and the side walls 211d and 213d are in the shadow of front end 209d. This general tapered shape helps minimize the wear that the rearward portions of the tip 201d experience. In addition, the larger front end 209d minimizes the wear the bottom rear end of the base 101d will experience. Alternatively, the tip 201d may be provided without a taper or tip 201c may be provided with a taper similar to tip 201d.

The bottom or distal mounting end 117d of base 101d is provided with a groove or recess 123d for receipt of retainer 301d. Recess 123d extends from the rear surface 107d to a distance shy of the front surface 109d. A recess that does not extend through the front surface may provide a base that has a leading surface that has a higher strength than a base that has a groove from the rear surface to the front surface. In addition, because the recess 123d does not extend through the front surface the recess is provided with a natural stop 124d to maintain the retainer within the recess 123d. Alternatively the recess 123d may extend all the way through the base 101d from the front surface 109d to the rear surface 107d.

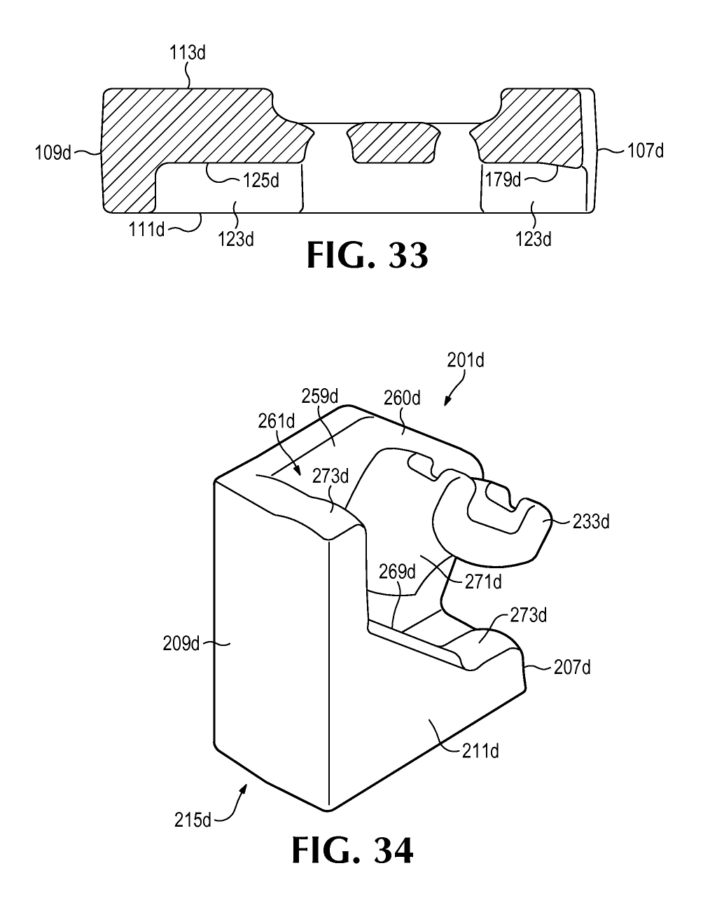

Recess 123d may be provided with one or more ramps 179d. In the illustrated embodiment, recess 123d is provided with one ramp 179d adjacent rear surface 107d so that side surface 125d of recess 123d preferably has a portion that is not planer (FIG. 33). Ramp 179d allows the depth of the recess 123d to be minimized adjacent the rear end 107d. Minimizing the depth of the recess 123d allows the base 101d to have an increased thickness to strengthen the base 101d and minimize the high stress zones the recess may create. In alternative embodiments, recess 123d may be provided with only one ramp adjacent the front surface, may have multiple ramps, could have no ramps, or may be provided with ramps that slope outward so that the end of the ramp is flush with side surface 111d. Alternatively, the recess may be provided with no ramps and the recess may have a side surface similar to recess 123c of hammer 22c.

A through hole 133d extends through base 101d for receipt of protrusion 233d on tip 201d. Through hole 133d generally matches the shape of protrusion 233d on the tip. Through hole 133d has multiple surfaces 155d that are generally parallel to the axis of rotation R_{d}. However, unlike through hole 133c in base 101c, through hole 133d generally does not have a surface that is normal to the centrifugal force F of the hammer spinning around the drum, instead through hole 133d is provided with a rear surface 151d that is generally perpendicular to the axis of rotation R_{d}. Through hole 133d also does not have one surface that is generally parallel to the centrifugal force F of the hammer spinning around the drum. Instead through hole 133d is provided with a front surface 153d that is generally perpendicular to the axis of rotation R_{d}. A generally convex surface 156d connects the front surface 153d to the rear surface 151d. Alternatively, surface 156d may be generally planer.

Similarly, the mounting end 217d of tip 201d has a protrusion 233d for receipt in a through hole 133d in base 101d. Protrusion 233d generally matches the shape of through hole 133d. Protrusion 233d has multiple surfaces 255d that are generally parallel to the axis of rotation R_{d}, at least two surfaces 251d and 253d that are generally perpendicular to the axis of rotation R_{d}, and at least one generally convex surface 256d to bear against the surfaces on base 101d. Alternatively, surface 256d may be generally planer. The transitions between the various surfaces of the protrusion 233d are preferably beveled to increase the strength of the ears 275d formed from groove 223d and recess 224d.

A bottom recess 169d along sidewall 164d and adjacent bottom surface 165d of protrusion 161d defines pivot axis R_{d} about which tip 201d rotates onto base 101d. Recess 169d is preferably concave or cylindrical to receive a protrusion 269d on the tip 201d. Tip 201d similarly has a protrusion 269d that is preferably convex to form a bulb that is received within the recess 169d of base 101d (i.e., protrusion 269d rotates about pivot axis R_{d} on base 101d). Alternatively, the protrusion could be located on the base 101d and the recess could be located on the tip 201d.

FIGS. 34-37 shows that tip 201d is provided with curved inner surfaces 271d on the underside of protrusion 233d and an outer curved surface 273d that connects the outer side wall 211d of wear end 215d to the inner side wall 264d of recess 261d. Curved inner surface 171d and outer curved surface 173d on base 101d provide sufficient clearance for tip 201d to rotate onto the base 101d. Curved inner surface 271d and curved outer surface 273d fill the gaps created by curved inner surface 171d and curved outer surface 173d. Preferably inner curved surface 271d is concentric about pivot axis R_{d}. Once the tip 201d is rotated onto base 101d curved surface 271d abuts an inner curved surface 171d on base 101d (FIG. 29) and outer curved surface 273d abuts an outer curved surface 173d on base 101d (FIG. 30).

To assemble tip 201d on base 101d, protrusion 269d on tip 201d is aligned with the pivot axis R_{d} on base 101d (i.e., protrusion 269d of tip 201d is aligned with recess 169d of base 101d). The tip 201d is then rotated about the pivot axis R_{d} until inner surface 260d of sidewall 259d abuts a recess 157d on base 101d to prevent further inward rotation of the tip 201d. Retainer 301d is then inserted into the bottom or back end of recess 123d on base 101d.

The above disclosure describes specific examples of hammers for use with material reducing equipment. The hammers include different aspects or features of the invention. The features in one embodiment can be used with features of another embodiment. The examples given and the combination of features disclosed are not intended to be limiting in the sense that they must be used together.

1. A replaceable tip for a hammer to separate material in a reducing machine, the tip comprising a wear end to contact the material to be reduced and a mounting end adapted to mount to a base on a driven head of the reducing machine, the mounting end including a plurality of bearing surfaces to bear against corresponding bearing surfaces on the base, the bearing surfaces being at an acute angle to a centrifugal force experienced as the tip spins around the drum and generally parallel to the direction the tip is installed on the base.

2. A replaceable tip in accordance with claim 1 wherein the mounting end includes a transverse protrusion to fit within an opening in the base, the protrusion having a depth in a direction of insertion into the opening, a length and a width shorter than the length.

3. A replaceable tip in accordance with claim 2 wherein the bearing surfaces are on the protrusion.

4. A replaceable tip in accordance with claim 1 wherein both the mounting end and the wear end have a leading portion in a primary direction of rotation, a trailing portion opposite the leading portion, and a pair of side portions extending between the leading and trailing portions, the mounting end and the wear end being connected by a single protrusion extending downward from one of the said side portions on the mounting end to one of the said side portions of the wear end so that the other of the said side portions on the mounting end and the other said side portions on the wear end are free of a connection.

5. A replaceable tip in accordance with claim 1 wherein the wear end including an exterior wear surface for engaging the material and an interior surface being adjacent the exterior wear surface and bearing against the base as the exterior wear surface engages the material, the interior surface having a front end, a bottom end, and a transition surface that curves from the front end toward the bottom end, the transition surface generally matching a shape of the exterior wear surface once the tip has experienced wear.

6. A replaceable tip in accordance with claim 1 wherein the mounting end includes a fulcrum about which the tip rotates to mount to the base.

7. A replaceable tip in accordance with claim 6 wherein the fulcrum extends at an acute angle to a centrifugal force experienced as the tip spins around the drum.

8. A replaceable tip in accordance with claim 6 wherein the fulcrum is angled between 35 and 90 degrees relative to the centrifugal force.

9. A replaceable tip in accordance with any one of claim 6 wherein the fulcrum is inclined about 45 degrees relative to the centrifugal force.

10. A replaceable tip in accordance with claim 1 including a front surface facing generally in the direction of travel and an opposite rear surface, and the mounting end including a groove extending generally in a direction from the front surface to the rear surface to receive a retainer to hold the tip to the base.

11. A replaceable tip in accordance with claim 10 wherein the groove is inclined relative to the centrifugal force.

12. A replaceable tip in accordance with claim 1 wherein the mounting end includes a first bearing face extending generally parallel to the centrifugal force, and a second bearing face extending generally perpendicular to the centrifugal force.

13. A replaceable tip for a hammer to separate material in a reducing machine, the tip comprising a wear end to contact the material to be reduced and a mounting end adapted to mount to a base on a driven head of the reducing machine, the mounting end including a transverse protrusion to fit within an opening in the base, the protrusion having a depth in a direction of insertion into the opening, a length and a width shorter than the length.

14. A replaceable tip in accordance with claim 13 wherein both the mounting end and the wear end have a leading portion in a primary direction of rotation, a trailing portion opposite the leading portion, and a pair of side portions extending between the leading and trailing portions, the mounting end and the wear end being connected by a single protrusion extending downward from one of the said side portions on the mounting end to one of the said side portions of the wear end so that the other of the said side portions on the mounting end and the other said side portions on the wear end are free of a connection.

15. A replaceable tip in accordance with claim 13 wherein the wear end including an exterior wear surface for engaging the material and an interior surface being adjacent the exterior wear surface and bearing against the base as the exterior wear surface engages the material, the interior surface having a front end, a bottom end, and a transition surface that curves from the front end toward the bottom end, the transition surface generally matching a shape of the exterior wear surface once the tip has experienced wear.

16. A replaceable tip in accordance with claim 13 wherein the mounting end includes a fulcrum about which the tip rotates to mount to the base.

17. A replaceable tip for a hammer to separate material in a reducing machine, the tip comprising a mounting end to receive the base and a wear end for engaging the material, wherein both the mounting end and the wear end have a leading portion in a primary direction of rotation, a trailing portion opposite the leading portion, and a pair of side portions extending between the leading and trailing portions, the mounting end and the wear end being connected by a single protrusion extending downward from one of the said side portions on the mounting end to one of the said side portions of the wear end so that the other of the said side portions on the mounting end and the other said side portions on the wear end are free of a connection.

18. A replaceable tip in accordance with claim 17 wherein the wear end including an exterior wear surface for engaging the material and an interior surface being adjacent the exterior wear surface and bearing against the base as the exterior wear surface engages the material, the interior surface having a front end, a bottom end, and a transition surface that curves from the front end toward the bottom end, the transition surface generally matching a shape of the exterior wear surface once the tip has experienced wear.

19. A replaceable tip in accordance with claim 17 wherein the mounting end includes a fulcrum about which the tip rotates to mount to the base.

20. A replaceable tip for a hammer to separate material in a reducing machine, the tip comprising a mounting end to receive the base and a wear end for engaging the material, the wear end including an exterior wear surface for engaging the material and an interior surface being adjacent the exterior wear surface and bearing against the base as the exterior wear surface engages the material, the interior surface having a front end, a bottom end, and a transition surface that curves from the front end toward the bottom end, the transition surface generally matching a shape of the exterior wear surface once the tip has experienced wear.

21. A replaceable tip in accordance with claim 20 wherein the mounting end includes a fulcrum about which the tip rotates to mount to the base.

22. A replaceable tip for a hammer to separate material in a reducing machine, the tip comprising a wear end to contact the material to be reduced and a mounting end adapted to mount to a base on a driven head of the reducing machine, the mounting end including a fulcrum about which the tip rotates to mount to the base.

23. A replaceable tip in accordance with claim 22 wherein the fulcrum extends at an acute angle to a centrifugal force experienced as the tip spins around the drum.

24. A replaceable tip in accordance with claim 23 wherein the fulcrum is angled between 35 and 90 degrees relative to the centrifugal force.

25. A replaceable tip in accordance with claim 23 wherein the fulcrum is inclined about 45 degrees relative to the centrifugal force.

26. A replaceable tip in accordance with claim 22 including a front surface facing generally in the direction of travel and an opposite rear surface, and the mounting end including a groove extending generally in a direction from the front surface to the rear surface to receive a retainer to hold the tip to the base.

27. A replaceable tip in accordance with claim 26 wherein the groove is inclined relative to the centrifugal force.

28. A replaceable tip in accordance with claim 22 wherein the mounting end includes a first bearing face extending generally parallel to the centrifugal force, and a second bearing face extending generally perpendicular to the centrifugal force.

29. A hammer for reducing material in a reducing machine comprising:
a base including a leading surface facing in a primary direction of rotation, a trailing surface opposite the leading surface, a pair of side surface extending between the leading and trailing surfaces, a proximate end for mounting the base to the reducing machine, and a distal end comprising a plurality of bearing surfaces;
a replaceable tip comprising a wear end to contact the material to be reduced and a mounting end adapted to mount on the distal end of the base, the mounting end including a plurality of bearing surfaces to bear against the bearing surfaces on the base, the bearing surfaces on the base and on the replaceable tip being at an acute angle to a centrifugal force experienced as the tip spins around the drum and generally parallel to the direction the tip is installed on the base; and
a retainer to secure the replaceable tip to the base.

30. A hammer in accordance with claim 29 wherein the base and the tip each include a recess which collectively define an opening into which the retainer is received.

31. A hammer in accordance with claim 18 wherein the recess in the base extends only partially through the base.

32. A hammer in accordance with any of claim 29 wherein one of the side surfaces of the base defines a pivot axis for installing the tip.

33. A hammer for reducing material in a reducing machine comprising:
a base including a leading surface facing in a primary direction of rotation, a trailing surface opposite the leading surface, a pair of side surface extending between the leading and trailing surfaces, a proximate end for mounting the base to the reducing machine, and a distal end comprising an opening;
a replaceable tip comprising a wear end to contact the material to be reduced and a mounting end adapted to mount on the distal end of the base, the mounting end including a transverse protrusion to fit within the opening in the base, the protrusion having a depth in a direction of insertion into the opening, a length and a width shorter than the length; and
a retainer to secure the replaceable tip to the base.

34. A hammer for reducing material in a reducing machine comprising:
a base including a leading surface facing in a primary direction of rotation, a trailing surface opposite the leading surface, a pair of side surface extending between the leading and trailing surfaces, a proximate end for mounting the base to the reducing machine, and a distal end;
a replaceable tip comprising a wear end to contact the material to be reduced and a mounting end adapted to mount on the distal end of the base, wherein both the mounting end and the wear end have a leading portion in a primary direction of rotation, a trailing portion opposite the leading portion, and a pair of side portions extending between the leading and trailing portions, the mounting end and the wear end being connected by a single protrusion extending downward from one of the said side portions on the mounting end to one of the said side portions of the wear end so that the other of the said side portions on the mounting end and the other said side portions on the wear end are free of a connection; and
a retainer to secure the replaceable tip to the base.

35. A hammer for reducing material in a reducing machine comprising:
a base including a leading surface facing in a primary direction of rotation, a trailing surface opposite the leading surface, a pair of side surface extending between the leading and trailing surfaces, a proximate end for mounting the base to the reducing machine, and a distal end;
a replaceable tip comprising a wear end to contact the material to be reduced and a mounting end adapted to mount on the distal end of the base, the wear end including an exterior wear surface for engaging the material and an interior surface being adjacent the exterior wear surface and bearing against the base as the exterior wear surface engages the material, the interior surface having a front end, a bottom end, and a transition surface that curves from the front end toward the bottom end, the transition surface generally matching a shape of the exterior wear surface once the tip has experienced wear; and
a retainer to secure the replaceable tip to the base.

36. A hammer for reducing material in a reducing machine comprising:
a base including a leading surface facing in a primary direction of rotation, a trailing surface opposite the leading surface, a pair of side surface extending between the leading and trailing surfaces, a proximate end for mounting the base to the reducing machine, and a distal end;
a replaceable tip comprising a wear end to contact the material to be reduced and a mounting end adapted to mount on the distal end of the base, the mounting end including a fulcrum about which the tip rotates to mount to the base; and
a retainer to secure the replaceable tip to the base.

37. A replaceable tip in accordance with claim 36 wherein the fulcrum extends at an acute angle to a centrifugal force experienced as the tip spins around the drum.

38. A replaceable tip in accordance with claim 37 wherein the fulcrum is angled between 35 and 90 degrees relative to the centrifugal force.

39. A replaceable tip in accordance with claim 37 wherein the fulcrum is inclined about 45 degrees relative to the centrifugal force.
